(19) United States
(12) Patent Application Publication
(10) Pub. No.: US 2026/0236707 A1
(43) Pub. Date: Aug. 13, 2026

(54) CONTAINER SYSTEM IMPLEMENTING A CONVERSATION ASSISTANT

(71) Applicant: PA.COTTE SA, Pully (CH)

(72) Inventors: Pierre-Alain Cotte, Amberg (DE); Christian Jacquemot, Saint Germain Les Corbeil (FR); Jérôme Colin, Avrillé (FR)

(73) Assignee: PA.COTTE SA, Pully (CH)

(21) Appl. No.: 19/469,296

(22) PCT Filed: Mar. 22, 2024
(86) PCT No.: PCT/EP2024/057771

§ 371 Date: Sep. 25, 2025

(30) Foreign Application Priority Data
Mar. 27, 2023 (FR) 2302906

(51) Int. Cl. G06F 40/35; G10L 15/26

(52) U.S. Cl. CPC G06F 40/35; G10L 15/26

(57) ABSTRACT

The invention relates to an object-transporting system allowing a conversational exchange. According to the invention, such a system comprises at least one container configured so as to capture a first datum coming from a user; and an intelligent conversational agent configured to: receive the first datum, transmitted by said container; perform a semantic analysis of the first datum; produce, optionally, a second datum resulting from the semantic analysis; transmit, optionally, the second datum to said at least one container; said container being moreover configured so as to process the second received datum.

### 1. FIELD OF THE INVENTION

The invention relates to the field of conversational artificial intelligence related to connected objects, known by the terminology IoT (Internet of Things).

More precisely, the invention relates to an intelligent container, intended for the transportation of products, parts or objects.

The invention in particular finds an application in the conveyance of packages or parcels, used in the field of logistics transport for the delivery of products.

### 2. PRIOR ART

In the field of logistics, it is known to label a parcel to identify its destination, sort it and forward it over logistics platforms to its recipient. Such a technique suffers from the need to add multiple labels according to the number of logistics service providers involved in the transportation. Moreover, this elementary technique includes many drawbacks related to the absence of a detached label, legibility problems, and the impossibility of tracking the parcel between two points of identification in logistics platforms. Consequently, many parcels are lost and in some cases stolen.

A need has thus become apparent for the use of packages equipped with an embedded electronic unit with a screen serving as a label and able to transmit items of position information with a supervision platform, over the logistical itinerary taken.

Finally, to reinforce the security of these packages, parcel-locking means have been added, permitting opening under particular conditions, to limit access to the authorized person, very often the end recipient.

However, these developments in packages for shipping and transporting an object are not without their drawbacks.

Specifically, as soon as a new type of labeling enters into use, it is necessary to revise and reformulate the processes, envision nominal operation and situations of processing errors in the logistics chain.

Another drawback of such a technique is that it then requires all the professionals of the logistics chain to be trained in this new use, which is often specific.

Yet another drawback of this technique is that when the recipient receives his parcel, although he has been able to track its route, he has no information about its transportation.

### 3. SUBJECTS OF THE INVENTION

The invention thus in particular has the objective of palliating the drawbacks of the prior art mentioned above.

More precisely the invention has the objective of providing an object-transporting system allowing a conversational exchange between a user and the transportation package.

One objective of the invention is also to provide such a technique which is simple to implement by the user.

Another objective of the invention is to provide such a technique allowing relevant exchanges with the user.

An objective of the invention is also to make provision for such a technique allowing a conversation centered on the profile of the sender.

Yet another objective of the invention is to provide such a technique in a way that is reliable, and without danger to the consumer.

### 4. SUMMARY OF THE INVENTION

These objectives, along with others that will become apparent in the remainder of the text, are achieved using an object-transporting system allowing a conversational exchange.

In the context of the invention, the system comprises at least one container configured so as to capture a first datum. The system also comprises an intelligent conversational agent configured to:
a) receive the first datum, transmitted by the container;
b) perform a semantic analysis of said first datum;
c) produce, optionally, a second datum resulting from the semantic analysis;
d) transmit, optionally, said second datum to said at least one container;
Furthermore, in this system, the container is configured so as to process the second received datum.

Thus, in such a system, owing to these technical features it is possible to initiate a conversation in which the container sends data to an intelligent agent which after semantically analyzing them can answer him with the result of its analysis.

According to a preferred embodiment of the invention, the first datum and the second datum are so-called communication data which form a conversational exchange, and wherein
the first datum comes from a user of the container;
the processing of the second datum by the container consists in communicating the second datum to said user,
the intelligent conversational agent is moreover configured so as to:
keep an item of context information based on the conversational exchange,
use the item of context information during said semantic analysis.

Owing to these features, a user can query the container in natural language and obtain in return assistance, and/or additional information, provided in natural language. Moreover, the user can, by a series of sequenced question/answers, converse with the container.

In addition, the intelligent conversational agent possesses the history of questions and answers exchanged with the user and can thus refine its analysis so as to increase the accuracy of its answers.

According to an advantageous embodiment of the invention, the first datum is a so-called information datum, of the type: an identifier, or a physical quantity, or an operating configuration.

Owing to these features, the intelligent conversational agent receives items of information about the context of the container. These items of information may be single, paired or composite to provide a variable level of accuracy about the collected items of information. The first so-called information datum can for example comprise the internal temperature alone and/or the external temperature, the internal and/or external atmospheric pressure. This can also be items of information related to its motion, such as an acceleration, or a position by satellite location. Thus, from the item of motion information, the intelligent conversational agent can deduce the exposure of the container to an impact, to vibrations, or to a fall. In the case of the fall the fall height and/or acceleration may complete the item of information.

Advantageously, the identifiers are identifiers specific to the application, or identifiers of known type, such as that of a SIM® (Subscriber Identify Module) card, or else an NFC® (Near-Field Communication) card.

According to a particularly advantageous embodiment of the invention, the second datum, resulting from the semantic analysis of the first so-called information datum, is a command applied by said container. Owing to these features, optionally according to the result of the semantic analysis, a second datum is produced, then sent to the container which can then make use of it. Thus, the intelligent conversational agent can choose between issuing a text or voice message and command different actions, particularly controlling a Light Emitting Diode (LED), a siren or a loudspeaker, a motor, a display screen, a locking/unlocking device. Thus, the intelligent conversational agent can for example command a blinking mode of the LEDs to attract the attention of the user.

According to a preferred embodiment of the invention, the intelligent conversational agent is configured so as to:
store the first so-called information datum in a continual learning parameter database; and
train a model of the intelligent conversational agent with the continual learning parameters stored in said database.

Owing to these features, the intelligent conversational agent increases its knowledge base, so as to enrich its answers and/or improve the relevance thereof.

According to a particular aspect of the invention, the training is automatic.

According to a particularly advantageous embodiment of the invention, the training is deep learning, in which each continual learning parameter has an associated weighting of positive or negative approval of said parameter.

Thus, using algorithms of “machine learning” or “deep learning” type the value of the learning data is qualified, improving the reliability of subsequent semantic analyses.

According to an embodiment, the container comprises a means for inputting said first so-called communication datum, which is a voice capturing means and/or a textual inputting means.

Owing to these features, the user can query the container directly in natural language orally and/or use an inputting means, such as a touch-sensitive or mechanical keyboard, or else a stylus associated with a handwriting recognizing means, to communicate with the container. According to a particular embodiment of the invention, the inputting means is an independent remote control, short-range, such as a smartphone. The smartphone then communicates with a short-range wireless communication means such as a Bluetooth®, BLE® (Bluetooth Low Energy) or Wi-Fi® protocol.

Owing to these features, it is possible to produce containers at reduced prices and thus expand the target customer base of the product.

According to an advantageous embodiment of the invention, the system comprises a means of text transcription of said voice capture, such that the intelligent conversational agent receives a first datum in text format.

Owing to these features, using speech, the user may communicate with the container, the captured voice message of which is converted into a text message received by the intelligent conversational agent, and directly interpretable by a conversational artificial intelligence.

According to an embodiment, the container comprises a means of sound reproduction, and/or a means of display, of said second so-called communication datum.

Owing to these features, the user receives a reply to the query he has submitted indirectly to the intelligent conversational agent by way of the container.

According to an advantageous embodiment of the invention, the system comprises a means of voice transcription of the second so-called communication datum produced in the text format by the intelligent conversational agent. Owing to these features, the user receives a voice answer.

According to an embodiment, the container is selected from a group comprising an item of baggage, a reusable box.

Thus, in a novel and non-obvious manner, a reusable box, a reusable logistics delivery package, an electronic logistics label intended to equip a single-use package and also an item of baggage, such as a transport case, allow a user to converse to obtain different types of information, particularly items of information facilitating the use of the container.

In a particularly advantageous embodiment of the invention, the intelligent conversational agent is integrated into an embedded computer unit of said container and/or onto a central computer platform configured to communicate with said container.

Owing to these features, it is possible to have either a stand-alone container with a localized intelligence, or a container supported by an intelligence remoted to a distant central computer platform. It is also possible to distribute, or accumulate an intelligence on either side between the central computer platform and the container, to increase the relevance and/or speed of the answers, or else distribute the processing load according to the dimensions of the embedded processing power in the container.

In addition, a localized intelligence in each container also offers the advantage, particularly in the case of an item of baggage, of improving confidentiality and/or privacy.

Moreover, such a localized intelligence palliates the absence of connectivity with the central computer platform in the event of a malfunction of the long-distance communication means. This also makes it possible to reduce the power consumption of the long-distance communication module. This also makes it possible to manage and therefore minimize the 4G data consumption volume.

According to a particular embodiment of the invention, the intelligent conversational agent is remoted to an external computer platform configured to communicate with said central computer platform.

Owing to these features, the intelligent conversational agent is remoted to an external platform at a specialist provider for example.

According to a particular embodiment of the invention, the transportation system further comprises a means of communication with a worldwide computer network. According to variant embodiments the communication means connects the central computer platform and/or the external computer platform to the worldwide computer network.

Owing to these features, the intelligent conversational agent is able to complete its learning by consulting the internet. Moreover, it can enrich its answers with information collected from the worldwide computer network, such as for example weather information related to a temperature peak recorded by the container in a given place.

According to an advantageous embodiment of the invention:
the container is configured so as to identify the user, categorize the identified user in a typical conversation profile and transmit the typical conversation profile to the intelligent conversational agent;
the intelligent conversational agent being configured so as to adapt the semantic analysis according to the typical conversation profile.

Owing to these features, the intelligent conversational agent is able to provide targeted information according to the typical conversation profile and therefore according to the role of the user who can have the role of a customer receiving a parcel, that of a logistician responsible for conveying it, or else the role of an agent in charge of the maintenance of the reusable parcel. Thus, the identified maintenance agent can, using voice command keywords, obtain items of diagnostic information, or else items of information or recommendations from the after-sales service manual, which are not available for the other roles.

According to an embodiment of the invention, the identification of the user is completed by an authentication.

Thus, using this technique, it is possible to ensure, for example, that only the recipient customer can obtain the opening of the container, at the time of delivery.

According to a particularly advantageous embodiment of the invention the intelligent conversational agent is configured so as to choose a conversation language according to a position of the container, received in the first so-called information datum. The position, which is a physical location quantity, is typically the most recent GPS position of the container. But it can also be deduced from other items of information, such as the current cellular telephony cell, or the known position of the current storage warehouse and/or its Wi-Fi® network to which the container can be connected. Thus, the intelligent conversational agent dialogs in the local language when the latter is available, or switches to an international language, typically English, or Spanish or French.

Advantageously, the intelligent conversational agent uses the location position to determine local culture criteria and adapt the produced answers to these criteria.

Certain aspects of the invention start from the idea of implementing progresses in artificial intelligence in the conversational field, particularly with LLM (Large Language Models), of “generative pre-trained transformer” type, such as services such as GPT3® and ChatGPT® from OpenAI®, Bert® and Bard® from Google®, or else with generative artificial intelligence.

### 5. LIST OF FIGURES

Other features and advantages of the invention will become more clearly apparent on reading the following description of two embodiments of the invention, given by way of simple illustrative and non-limiting examples, and the appended drawings among which:

FIG. 1 is a schematic representation of an exemplary embodiment of an object-transporting system featuring a communicating container according to the invention;

FIG. 2 is a schematic representation of a second exemplary embodiment of an intelligent item of baggage according to the invention.

### 6. DETAILED DESCRIPTION OF THE INVENTION

### 1. Exemplary Embodiment of the Invention

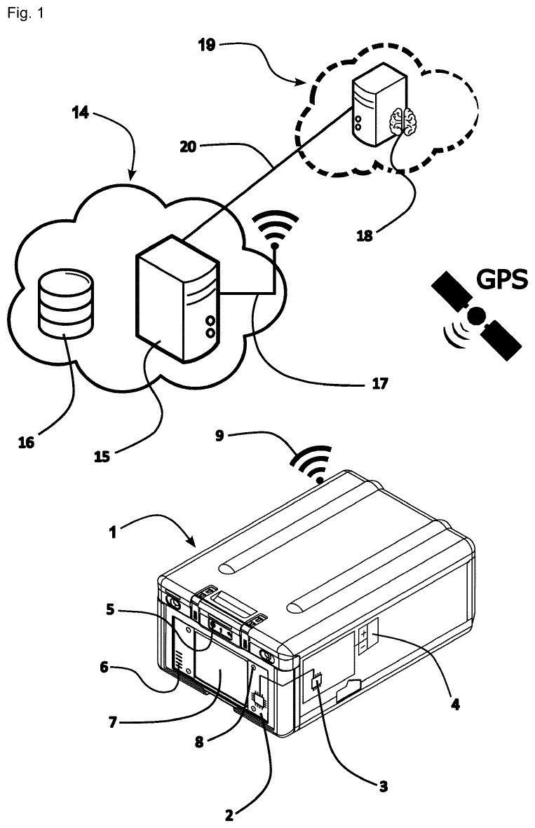

FIG. 1 illustrates a first embodiment of an object-transporting system according to the invention, comprising a container 1, a computer infrastructure 14 and an external computer platform 19.

The container 1 allowing a conversational exchange includes electronic means including an embedded computer unit 2, data-storing means 3, an electrical power supply battery 4, a microphone 5, a loudspeaker 6, a digital screen 7, one or more control buttons 8, a first communication means 9, one or more actuators (not shown), the whole assembled using techniques known per se.

It moreover includes a large number of sensors (not shown), to obtain various items of information, related to its storage, its transportation, or its environment. Thus, it may obtain a “GPS” (Global Positioning System) position used to track its movement, an item of motion information, and deduce when it has undergone an impact, deduce its exposure to vibrations, or else register a fall. The container 1 is also able to record internal and/or external information such as a temperature, an atmospheric pressure. These various items of information also include an identifier specific to the container 1, an identifier specific to the computer unit 2, a SIM (Subscriber Identify Module) card, an NFC (Near-Field Communication) code, or any other known identifier known per se by those skilled in the art.

The computer infrastructure 14 includes a computer platform 15, a database 16 and a second communication means 17 to communicate via the first communication means 9, with the computer unit 2 of the container 1.

Moreover, the computer infrastructure 14 is able to communicate using a third communication means 20 with the external computer platform 19.

In this embodiment, the external computer platform 19 includes a conversational artificial intelligence module, typically software, which constitutes a conversational agent 18 configured to:
a) receive a captured datum, transmitted by the container 1 via the computer infrastructure 14;
b) perform a semantic analysis of the captured datum;
c) produce a datum resulting from the semantic analysis; and
d) transmit, via the computer infrastructure 14, the resulting datum to the container 1;

A conversation begins, when the captured datum is a first so-called communication datum, and the resulting datum is a second so-called communication datum. In this case, the first communication datum and the second communication datum are stored by the conversational agent 18 using methods known per se, to retain an item of context information. It is then a history of the conversation composed of these items of context information which is enriched as the conversations go on.

To initiate a conversation, a user presses the button 8 of the container 1. The computer unit then triggers an audio capture using the microphone 5 and records the voice message made by the user. Then, it transmits this voice message, called the first captured voice message, to the computer infrastructure 14. The latter, equipped with voice-to-text conversion means known as “speech to text” and “text to speech” is in charge of transcribing the first voice message into a corresponding first text message. The computer infrastructure 14 then transmits this first voice message to the conversational agent 18 over the external computer platform 19.

In a conversation, the resulting datum, which is a second text message, is then received by the computer infrastructure 14. This converts the second text message into a second voice message and transmits it to the container 1. Then, the container 1 plays back the second voice message through the loudspeaker 6, for the attention of the user, which can continue the conversation. Thus, by this series of exchanges, the container 1 holds the conversation with the user.

Moreover, since it is equipped with other sources of information specified above, the container 1 is also configured to transmit at least one of the various items of information available as a captured datum message. By way of example, the transmitted captured datum conveys the item of information about its GPS position. Or else the captured datum contains a combination of items of information, such as the identifier, the internal temperature and the external temperature measured by the container 1.

When the captured datum is therefore not the voice message of the user but a so-called information datum, the resulting datum is a command transmitted to the container 1 which applies it to the at least one of the actuators. For example, the resulting command commands the unlocking of the container 1, authorizing its opening by the user. However, the voice message of the user can be interpreted by the conversational agent 18 such as an order to control one of the actuators. Nonetheless, in the configuration of the container 1 and/or of the conversational agent 18, the user cannot necessarily act on all the actuators equipping the container 1.

In the context of the object-transporting system, using a fleet of containers 1, it is the set of data escalated by the fleet of containers to the conversational agent 18 which contributes to the enrichment of the model.

Moreover, the contextualization of the container 1 makes it possible to guide the conversation in order to provide, to the user, the items of the information that are the most appropriate possible with regard to the container 1 and in particular its possibilities.

Moreover, items of context information are submitted to the learning of the model of the conversational agent 18, so as to impart to it a corpus of initial conditions. Typically, these items of context information concern the container 1, its description, its method of use, the possible uses, the frequent questions submitted by the users, the sales offer of object transportation using the container 1, or else items of information about the business managing the fleet of containers 1 that form the object-transporting system.

To do this, the conversational agent 18 undergoes a specialization of its model in which it is provided with a series of keywords and the associated semantics to form the corpus of initial conditions.

By way of example, the learning of the events associated with a shipment can be done according to the illustrative pseudocode below:
“Each stored event is composed of type, value where date is the date of the event, type is the type of the event and value is defined per type as follows:
‘sender’: name, address
‘recipient’: name, address
‘startShipment’: date, latitude, longitude
‘endShipment’: date, latitude, longitude
‘sensors’: date, ‘externalTemperature’, measure (in ° C.), ‘internalTemperature’, measure (in ° C.), ‘externalHumidity’, measure (in %), ‘internalHumidity’, measure (in %), ‘pressure’, measure (in hPa)
‘geolocation’: date, latitude, longitude
‘warehouse’: enterDate, exitDate, latitude, longitude, name
‘flight’: fromDate, fromLatitude, fromLongitude, fromAirport, toDate, toLatitude, toLongitude, toAirport
‘alert’: date, latitude, longitude, subtype (in ‘externalTemperature’, ‘internalTemperature’, ‘externalHumidity’, ‘internalHumidity’, ‘freeFall’), measure
‘events’: You will return every event containing the keyword ‘store’ as a list without displaying the keyword itself. When ‘event’ is followed by a type, return every events of the defined type as a list instead of all ‘store’ keywords and return the closest city instead of raw location coordinates.”

The learning of the associated semantics can be done as follows:
“A duration between two events event A and event B is defined as the difference between the date of the event B and the date of the event A.
The duration of an event is defined as the difference between the exitDate and the enterDate of the event or the toDate and the fromDate of the event”

The container 1 is for example a shipping parcel or package in accordance with the invention.

### 2. Other Exemplary Embodiments of the Invention

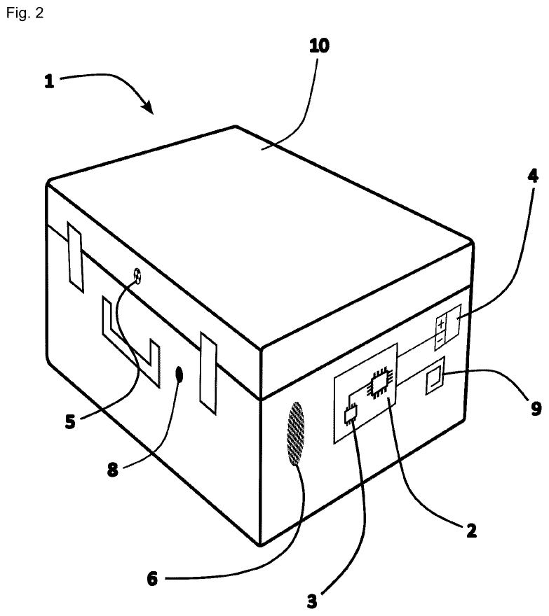

FIG. 2 shows the container 1 appearing in the form of an item of baggage, here a transport case 10 forming an object-transporting system according to a second embodiment of the invention.

The container 1 here also comprises electronic means including the embedded computer unit 2, the data storage means 3, the electrical power supply battery 4, the microphone 5, the loudspeaker 6, the button 8, assembled, according to techniques known per se. The embedded computer unit 2 of the transport case 10 is configured to capture, using the microphone 5, requests formulated by the user of the transport case 10 and emit answers via the loudspeaker 6. Thus, the microphone 5 and the loudspeaker 6 forms an interface with the user of the transport case 10.

Furthermore, the embedded computer unit 2 is configured to execute the intelligent conversational agent, and thus autonomously hold a conversation with the user of the transport case 10.

In addition, the embedded computer unit 2, using the communication means 9, is able to receive a specialized corpus chosen according to the intended use of the transport case 10. For example, this corpus is specialized for a particular journey, with information about the scheduled waypoints such as stations, airports, transport infrastructure of a city with information on a map of subway stations etc. The user can thus, via a conversation with the transport case 10, obtain items of information to locate himself in the maze of corridors of these waypoints.

In a variant of the second embodiment, the embedded computer unit 2 communicates with the communication means 9 with the intelligent conversational agent 18 remoted to the computer infrastructure 14, or to the external computer platform 19, not shown.

### 3. Other Optional Features and Advantages of the Invention

In variants of the embodiments of the invention detailed above, provision can also be made for:
recording, at the conversational agent 18, the captured datum in a database for storing continuous leaning parameters, when the captured datum is at least one of the various items of information, so as to train a model of said conversational agent 18, using a technique known by the term “machine learning”. Thus, the conversational agent 18 is able to train its model on the one hand and it is configured to train it automatically on the other hand;
associating the captured datum with a positive or negative approval weighting, taken into account by the model of the conversational agent 18. Thus, the training of the model is a form of “deep learning”. This increases the statistical analysis performance of the model and consequently the relevance of the conversational exchanges with the user;
integrating into the container means for identifying and/or authenticating the user to determine his role and consequently the conversation profile to be adopted.

The identification can be obtained by any known method, such as a badge, a voice recognition means, etc.;
integrating speech-to-text conversion means into the container 1, or remoting these means to the external platform, or else to a specialist provider.
integrating the conversational agent 18 into the computer infrastructure 14, particularly optimizing answer times;
embedding the conversational agent 18 into the computer unit 2 of the container 1 serving as shipping packaging, and thus giving it autonomy to converse with the user;
for the conversational agent 18 built into the computer unit 2, receiving continual learning parameters, optionally weighted, issued by the computer infrastructure 14, the learning parameters concerning the information feedback from a fleet of containers 1 in use;
specializing the intelligent conversational agent such that it adapts its semantic analysis according to the current location of the container;
transmitting a setpoint, in other terms a voice message for the attention of the user, following the analysis of captured data, for example to issue a message requiring greater care in the handling of the container 1 on detection of a fall;
using a touch-sensitive digital screen as an input and/or output interface between the container 1 and the user;
integrating the first communication means 9 into the electronic means of the transport case 10;
creating dedicated fleets for each customer of a logistics transporter, with a partitioning of the contextualization and therefore of the initial corpus used by the conversational agent 18 according to the specifics of the customer

The technique described above to produce an object transport system allowing a conversational exchange can be used with different types of receptacle, for example to form a container of freight container type.

It should be understood that the elements shown on the figures can be implemented in different forms of hardware, software or combinations thereof. Preferably, these elements are implemented in a combination of hardware and software on one or more multipurpose devices programmed in an appropriate manner, which may comprise a processor, a memory and input/output interfaces.

This description illustrates the principles of this disclosure. It will therefore be appreciated that persons skilled in the art will be able to conceive of various arrangements which, although not explicitly described or shown here, embody the principles of the disclosure and are included in its scope.

All the examples and the conditional language mentioned here are intended for educational purposes to help the reader understand the principles of the disclosure and the concepts provided by the inventor to advance the art, and must be interpreted as not being limited to these examples and conditions specifically mentioned.

Moreover, all the declarations of principles, aspects and embodiments of the disclosure, as well as the specific examples thereof, are intended to encompass their structural and functional equivalents. Moreover, it is intended for these equivalents to comprise both equivalents currently known and equivalents developed in the future, i.e. any developed element which fulfils the same function, independently of its structure.

Thus, for example, those skilled in the art will understand that the principle diagrams described here represent conceptual views of illustrative circuits implementing the principles of the disclosure. Similarly, it will be appreciated that all the block diagrams, flow charts and other diagrams represent various processes which may be essentially represented on a computer-readable medium and thus executed by a computer or a processor, whether or not this computer or this processor is explicitly represented.

The functions of the various elements illustrated on the figures can be fulfilled by the use of dedicated hardware as well as hardware capable of executing a software program in association with an appropriate software program. When they are fulfilled by a processor, the functions may be fulfilled by a single dedicated processor, a single shared processor, or by a plurality of individual processors, certain of which may be shared. In addition, the explicit use of the term “processor” or “controller” must not be interpreted as referring exclusively to the hardware capable of executing a software program, and may include implicitly, without limitation, a Digital Signal Processor (DSP), Read-Only Memory (ROM) for storing the software program, Random Access Memory (RAM), and a non-volatile storage medium. Moreover, certain elements may be independent or grouped, for example into a microcontroller (MCU), or a system on a component (SoC, acronym of System-on-Chip).

Other conventional and/or personalized software programs may also be included. Similarly, all the switches shown on the figures are solely conceptual. Their function may be executed by the operation of a program logic, by a dedicated logic, by the interaction of a program command and a dedicated software program, or even manually, the particular technique being selectable by the executant as more specifically understood in the context.

In the claims of this document, any element expressed as a means of executing a specified function is intended to encompass any way of executing this function, including, for example, a) a combination of circuit elements which executes this function or b) a software program in any form, including, consequently, a microprogram, a microcode or similar, combined with appropriate circuits for executing this software program in order to execute the function. The disclosure as defined by such claims resides in the fact that the functionality provided by the different mentioned means are combined and grouped together in the manner for which provision is made in the claims. It is therefore considered that all the means that these functionalities may provide are equivalent to those described here.

1.-13. (canceled)

14. An object-transporting system allowing a conversational exchange, comprising:
a fleet formed of at least one object-transporting container, of reusable baggage item or parcel type, the at least one container being configured so as to capture a first datum forming a constituent part of a set of data escalated by the fleet of containers, and
an intelligent conversational agent configured to:
a) receive the first datum, transmitted by said container;
b) perform a semantic analysis of said first datum;
c) produce, optionally, a second datum resulting from the semantic analysis;
d) transmit, optionally, said second datum to said at least one container;
said container being moreover configured so as to process the second received datum.

15. The object-transporting system of claim 14, wherein the first datum and the second datum are so-called communication data which form a conversational exchange, and wherein
said first datum comes from a user of said container;
said processing of the second datum by the container consists in communicating said second datum to said user,
the intelligent conversational agent is moreover configured so as to:
keep an item of context information based on the conversational exchange,
use the item of context information during said semantic analysis.

16. The object-transporting system of claim 14, wherein the first datum is a so-called information datum, of the type: an identifier, or a physical quantity, or an operating configuration.

17. The object-transporting system of claim 16, wherein the second datum, resulting from the semantic analysis of the first so-called information datum, is a command applied by said container

18. The object-transporting system of claim 16, wherein the intelligent conversational agent is configured so as to:
store the first so-called information datum in a continual learning parameter database; and
train a model of the intelligent conversational agent with the continual learning parameters stored in said database.

19. The object-transporting system of claim 16, wherein the intelligent conversational agent is configured so as to choose a conversation language according to a position of the container, received in the first so-called information datum.

20. The object-transporting system of claim 14, wherein the container comprises a means for inputting said first so-called communication datum, which is a voice capturing means and/or a textual inputting means.

21. The object-transporting system of claim 20, comprising a means of text transcription of said voice capture, such that the intelligent conversational agent receives a first datum in text format.

22. The object-transporting system of claim 14, wherein the container comprises a means of sound reproduction, and/or a means of display, of said second so-called communication datum.

23. The object-transporting system of claim 22, comprising a means of voice transcription of the second so-called communication datum produced in the text format by the intelligent conversational agent.

24. The object-transporting system of claim 14, wherein the intelligent conversational agent is integrated into an embedded computer unit of said container and/or onto a central computer platform configured to communicate with said container.

25. The object-transporting system of claim 24, wherein the intelligent conversational agent is remoted to an external computer platform configured to communicate with said central computer platform.

26. The object-transporting system of claim 14, wherein:
the container is configured so as to identify the user, categorize the identified user in a typical conversation profile and transmit the typical conversation profile to the intelligent conversational agent;
the intelligent conversational agent being configured so as to adapt the semantic analysis according to the typical conversation profile.
